(19) United States
(12) Patent Application Publication
(10) Pub. No.: US 2010/0326049 A1
(43) Pub. Date: Dec. 30, 2010

(54) COOLING SYSTEMS FOR ROTORCRAFT ENGINES

(75) Inventors: Marc Schmittenberg, Phoenix, AZ (US); Steve Newell, Phoenix, AZ (US)

Correspondence Address: HONEYWELL/IFL;Patent Services, 101 Columbia Road, P.O.Box 2245, Morristown, NJ, 07962-2245, US

(73) Assignee: HONEYWELL INTERNATIONAL INC., Morristown, NJ (US)

(21) Appl. No.: 12/491,950

(22) Filed: Jun. 25, 2009

(51) Int. Cl. F02K 99/00

(52) U.S. Cl. 60/266

(57) ABSTRACT

A cooling system is provided for an engine of a rotorcraft configured to generate a downwash into an atmosphere during operation. The system includes an inlet coupled to the engine and configured to receive a liquid from the engine; an outlet coupled to the engine and configured to return the liquid to the engine; and a body defining a conduit having a first end coupled to the inlet and a second end coupled to the outlet such that the liquid flows from the inlet to the outlet through the conduit and transfers heat to the atmosphere via the downwash from the rotorcraft.

### TECHNICAL FIELD

The present invention generally relates to engine cooling systems, and more particularly relates to engine oil cooling systems for rotorcraft.

### BACKGROUND

Most aircraft engines use oil for lubricating engine components. Heat generated by an aircraft engine is largely absorbed by this oil as it circulates through the engine, and the oil should be cooled, generally, with a cooling system. Conventional cooling systems are relatively complex and may adversely affect the overall efficiency of the engine. Various heat sink sources have been utilized and include fan or compressor bleed air and even engine fuel. Conventional cooling systems may include an air-oil heat exchanger such that air passes through the heat exchanger to cool the oil. Such an oil cooler generally requires a separate air flow feed which directs cooling air from the exterior of the engine to the oil cooler disposed therewithin.

As such, oil cooling systems generally require supplemental cooling air. The source of air commonly used for cooling engine oil is air bled from the initial stages of the compressor of the engine, or, in a turbofan engine, fan air from behind the fan. The air from each of these sources has pressure increased by the compressor or fan, and is thus warmer and consequently a less desirable source of cooling air.

Accordingly, it is desirable to provide improved engine cooling systems. In addition, it is desirable to provide engine cooling systems that do not require supplemental cooling air driven by an auxiliary fan. Furthermore, other desirable features and characteristics of the present invention will become apparent from the subsequent detailed description of the invention and the appended claims, taken in conjunction with the accompanying drawings and this background of the invention.

### BRIEF SUMMARY

In one exemplary embodiment, a cooling system is provided for an engine of a rotorcraft configured to generate a downwash into an atmosphere during operation. The system includes an inlet coupled to the engine and configured to receive a liquid from the engine; an outlet coupled to the engine and configured to return the liquid to the engine; and a body defining a conduit having a first end coupled to the inlet and a second end coupled to the outlet such that the liquid flows from the inlet to the outlet through the conduit and transfers heat to the atmosphere via the downwash from the rotorcraft.

In another exemplary embodiment, a rotorcraft includes an airframe; a rotor system coupled to the airframe and configured to generate a downwash during operation; an engine assembly configured to power the rotor system, the engine assembly configured to use oil for lubrication; and a cooling system comprising a conduit in flow communication with the engine assembly such that the oil is received by the cooling system, cooled by the cooling system, and returned to the engine assembly, the conduit being in heat transfer communication with the downwash to transfer heat from the oil to the downwash.

### BRIEF DESCRIPTION OF THE DRAWINGS

The present invention will hereinafter be described in conjunction with the following drawing figures, wherein like numerals denote like elements, and wherein:

FIG. 1 is a block diagram of an engine assembly with an engine cooling system in accordance with an exemplary embodiment;

FIG. 2 is a side view of a helicopter with an engine assembly in accordance with an exemplary embodiment;

FIG. 3 is a closer, isometric view of the engine assembly of FIG. 2;

FIG. 4 is a plan bottom view of an engine cooling system in accordance with an exemplary embodiment;

FIG. 5 is a first cross-sectional view of the engine cooling system of FIG. 4 through line V-V; and

FIG. 6 is a second cross-sectional view of the engine cooling system of FIG. 4 through line VI-VI.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

Broadly, exemplary embodiments discussed herein include engine cooling systems for cooling oil from a rotorcraft engine. In particular, the engine cooling systems are arranged on the nacelle of the rotorcraft such that downwash from the rotors during operation may be used to transfer heat from the oil to the atmosphere. The engine cooling system may include a conduit that transports the oil near the surface of the nacelle to improve heat transfer efficiency.

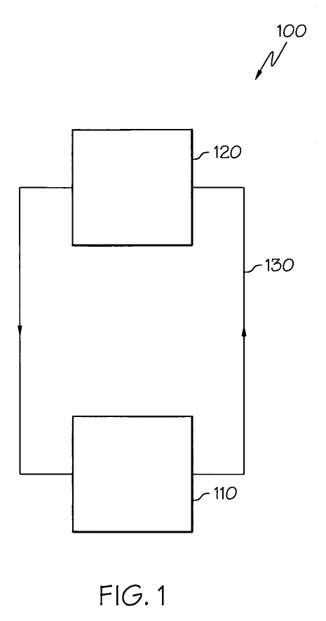

FIG. 1 is a block diagram of an engine assembly 100 in accordance with an exemplary embodiment. The engine assembly 100 includes an engine 110 and a cooling system 120 associated with the engine 110. The engine 110 can be any type of engine. As discussed below, the engine 110 can be a gas turbine engine for a rotorcraft, such as a turboshaft engine that contains a compressor section, a combustion section, and a turbine section. In general, the engine 110 uses one or more liquids 130 that absorb heat from the engine 110 during operation and that must be cooled. The cooling system 120 removes heat from the liquid 130 and returns the liquid 130 to the engine 110. In one exemplary embodiment, the liquid is oil that lubricates components within the engine 110 and the cooling system 120 is an oil cooler. As such, the oil has a cooling circuit such that the heated oil is directed to the cooling system 120, cooled by the cooling system 120, and returned to the engine 110.

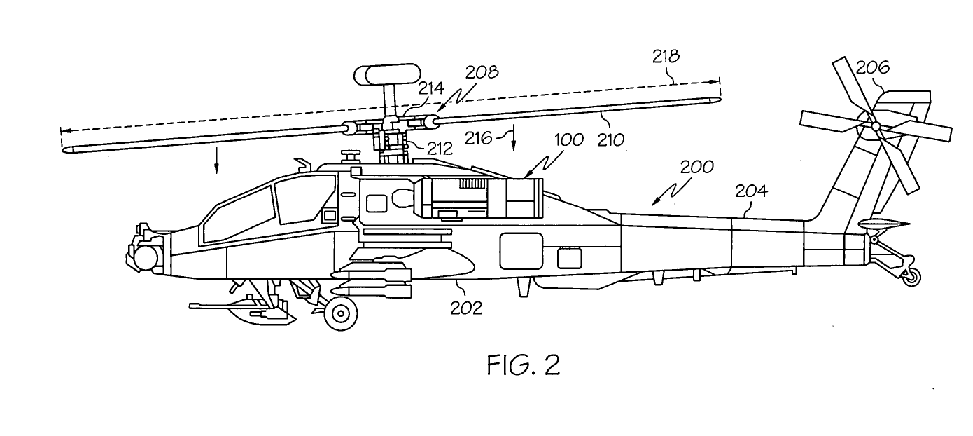

FIG. 2 is a side view of a rotorcraft 200 that includes an engine assembly 100 such as discussed above in FIG. 1. The engine assembly 100 powers a main rotor system 208 that include one or more horizontally mounted rotors 210 mounted on a mast 212 and hub 214. During operation, the rotors 210 generate a downwash 216 and resulting downforce for lifting the rotorcraft 200. The rotorcraft 200 includes an airframe 202 having an extending tail section 204 with an anti-torque tail rotor system 206. In FIG. 2, the rotorcraft 200 is a helicopter, although other rotorcraft, machines and configurations may utilize the exemplary embodiments discussed herein.

FIG. 3 is a closer, isometric view of the engine assembly 100 of FIG. 2. The engine assembly 100 includes a nacelle 300 that forms a cavity for housing the engine (not shown in FIG. 3) and other equipment. The nacelle 300 may be aerodynamically shaped and include an inlet 302 that supplies air to the engine and an exhaust 304 that exhausts air into the atmosphere. The nacelle 300 may include a removable nacelle door 306 that enables access to the interior of the nacelle 300, including the engine.

FIG. 3 additionally shows a top view of the engine cooling system 120. The engine cooling system 120 may be coupled to or form a portion of the nacelle 300. In the illustrated embodiment, the engine cooling system 120 forms part of the nacelle door 306. In general, the engine cooling system 120 approximately conforms to the aerodynamic shape of the nacelle 300 and is exposed to the atmosphere. In particular, the engine cooling system 120 is positioned on the nacelle 300 such that the engine cooling system 120 is exposed to the downwash 216 generated by the rotors 210 (FIG. 2) during operation. In other words, the rotors 214 have a diameter 218 and the engine cooling system 120 is within that rotor diameter 218.

As noted above, in this exemplary embodiment, the engine cooling system 120 receives heated oil from the engine and returns cooled oil to the engine. In particular, the engine cooling system 120 is a heat exchanger that transfers heat from the oil to the atmosphere. Particularly, the position of the engine cooling system 120 on the nacelle 300 exposes the engine cooling system 120 to the downwash 216 and enables a more efficient heat transfer to the atmosphere. The atmosphere generally has a much lower temperature than the heated oil, and the downwash 216 provides fresh air to the engine cooling system 120. The continual supply of cooler air from the atmosphere enables a more efficient heat transfer. In general, the cooling system 120 should be positioned to receive maximum flow from the rotor downwash 216.

The engine cooling system 120 may include surface-increasing devices, such as fins 122, to increase the efficiency of heat transfer. The number, arrangement, shape, and orientation of the fins 122 may be adjusted based on heat transfer efficiency, weight, and aerodynamic considerations. In illustrated exemplary embodiments, the fins 122 are generally perpendicular to the direction of travel and parallel to the general direction of the downwash 216.

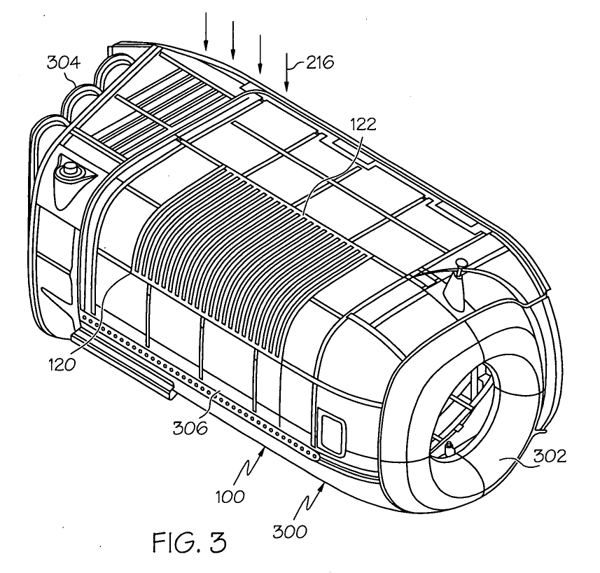

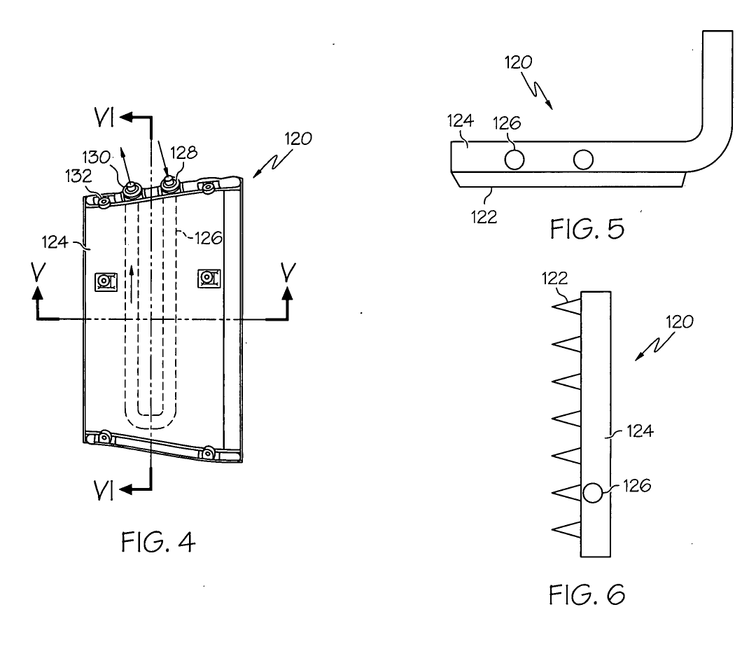

FIG. 4 is a plan bottom view of the engine cooling system 120 in accordance with an exemplary embodiment. FIGS. 5 and 6 show additional views of the engine cooling system 120. In particular, FIG. 5 is a first cross-sectional view of the engine cooling system 120 of FIG. 4 through line V-V, and FIG. 6 is a second cross-sectional view of the engine cooling system 120 of FIG. 4 through line VI-VI.

The engine cooling system 120 includes a body 124 that defines a conduit 126. In one exemplary embodiment, the body 124 is a plate-like structure that integrally defines the conduit 126. An inlet 128 couples a first end of the conduit 126 to the engine 110 (FIG. 1) for receiving the heated oil and an outlet 130 couples a second end of the conduit 126 to the engine 110 (FIG. 1) for returning the cooled oil. In general, the inlet 128 and outlet 130 are on the same end of the body 124 for easier installation, although other arrangements are possible. Installation mounts 132 may also be provided on the body 124 for installing the engine cooling system 120 on the nacelle 300 (FIG. 3). Moreover, only a single body 124 and conduit 126 are shown in FIG. 4. In further embodiments, the engine cooling system 120 may include a number of bodies and conduits coupled together with hoses for additional cooling capacity.

The conduit 126 is generally U-shaped and extends the length of the body 124 to maximize the path of the oil within the engine cooling system 120. In further embodiments, the conduit 126 may be serpentine-shaped and traverse the length of the body 124 more than twice to increase cooling time. As noted above, the conduit 126 may be integrally formed with the body 124 to improve heat transfer characteristics. The overall length of the conduit 126 may be dictated by the cooling requirements of the engine oil. Generally, a longer conduit 126 will provide increased cooling.

FIGS. 5 and 6 more particularly illustrate the fins 122 that increase the surface area of the body 124, and as such, the efficiency of heat transfer between the engine cooling system 120 and the atmosphere. The fins 122 extend outwardly form the body 124. In one exemplary embodiment, the fins 122 are attached to the conduit 126 to promote heat transfer. FIGS. 5 and 6 also illustrate that the engine cooling system 120 is a surface system and not a pass-through cooling system, such as a conventional radiator. By using the downwash 216 of the rotorcraft 200 (FIG. 2), the engine cooling system 120 cools the oil without requiring additional components, auxiliary fans, and/or engine air from the compressor section. This enables a more efficient cooling of the engine oil while achieving significant weight and space savings.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A cooling system for an engine of a rotorcraft configured to generate a downwash into an atmosphere during operation, comprising:
an inlet coupled to the engine and configured to receive a liquid from the engine;
an outlet coupled to the engine and configured to return the liquid to the engine; and
a body defining a conduit having a first end coupled to the inlet and a second end coupled to the outlet such that the liquid flows from the inlet to the outlet through the conduit and transfers heat to the atmosphere via the downwash from the rotorcraft.

2. The cooling system of claim 1, wherein the rotorcraft includes a nacelle configured to house the engine, and wherein the body is configured to form at least a portion of the nacelle.

3. The cooling system of claim 2, wherein the body is configured to form at least a portion of a door of the nacelle.

4. The cooling system of claim 2, wherein the body generally conforms to the nacelle.

5. The cooling system of claim 2, wherein the body has a first side coupled to the nacelle and a second side exposed to the atmosphere.

6. The cooling system of claim 5, further comprising cooling fins arranged on the second side of the body.

7. The cooling system of claim 1, wherein the body has a first longitudinal end and a second longitudinal end, and the inlet and outlet are arranged on the first longitudinal end.

8. The cooling system of claim 7, wherein the conduit is generally U-shaped and extends approximately from the first longitudinal end, to the second longitudinal end, and back to the first longitudinal end.

9. The cooling system of claim 1, wherein the conduit is integrally formed with the body.

10. A rotorcraft comprising:
an airframe;
a rotor system coupled to the airframe and configured to generate a downwash during operation;
an engine assembly configured to power the rotor system, the engine assembly configured to use oil for lubrication; and
a cooling system comprising a conduit in flow communication with the engine assembly such that the oil is received by the cooling system, cooled by the cooling system, and returned to the engine assembly, the conduit being in heat transfer communication with the downwash to transfer heat from the oil to the downwash.

11. The rotorcraft of claim 10, further comprising a nacelle coupled to the airframe and configured to house the engine, wherein the conduit forms part of the nacelle.

12. The rotorcraft of claim 11, wherein the nacelle has a door for accessing the engine assembly, the conduit forming part of the door of the nacelle.

13. The rotorcraft of claim 11, wherein the cooling system generally conforms to the nacelle.

14. The rotorcraft of claim 11, wherein the cooling system comprises a body that defines the conduit, the body having a first side coupled to the nacelle and a second side exposed to the downwash.

15. The rotorcraft of claim 14, further comprising cooling fins arranged on the second side of the body.

16. The rotorcraft of claim 14, wherein the body has a first longitudinal end and a second longitudinal end, the body further comprising an oil inlet and oil outlet arranged on the first longitudinal end.

17. The rotorcraft of claim 16, wherein the conduit is generally U-shaped and extends approximately from the first longitudinal end, to the second longitudinal end, and back to the first longitudinal end.

18. The rotorcraft of claim 14, wherein the conduit is integrally formed with the body.

19. A method for cooling oil from an engine in a rotorcraft generating a downwash, the method comprising the steps of:
receiving the oil in an engine cooling system;
exposing the oil to the downwash of the rotorcraft such that heat is transferred from the oil to the downwash; and
returning the oil to the engine.

20. The method of claim 19, wherein the exposing step includes transporting the oil through at least a portion of a nacelle of the rotorcraft.
